(19) United States
(12) Patent Application Publication
(10) Pub. No.: US 2008/0049964 A1
(43) Pub. Date: Feb. 28, 2008

(54) MULTIPLAYER GAMING SYSTEM WITH DIRECTIONAL AUDIO

(75) Inventors: Gunjan Porwal, Banjara Hills (IN); Murali Krishna Kocherla, Banjara Hills (IN)

Correspondence Address: ADVANCED MICRO DEVICES, INC.;C/O VEDDER PRICE KAUFMAN & KAMMHOLZ, P.C., 222 N.LASALLE STREET, CHICAGO, IL, 60601, US

(73) Assignee: ATI Technologies ULC, Markham (CA)

(21) Appl. No.: 11/761,664

(22) Filed: Jun. 12, 2007

(30) Foreign Application Priority Data
Jun. 29, 2006 (IN) 1112/CHE/2006

(51) Int. Cl. H04R 1/02

(52) U.S. Cl. 381/387

(57) ABSTRACT

A methods and systems for directing an audio stream produced by a home entertainment video hardware system are disclosed. These include sound reproducing devices intended to deliver audible messages to specific potential recipients. This requires generating an audio stream and identifying the recipients. Speakers associated with the recipients are identified. The audio stream is directed to the speakers so that only the intended recipients receive the audio stream whereas other recipients do not.

### FIELD OF THE INVENTION

The present invention relates to home-entertainment video hardware such as personal computers (PCs), game consoles, and DVD/CD/Blu-Ray Discs/HD-DVD/VCR players, and specifically, a method and system for directing audio streams to users of such hardware.

### BACKGROUND OF THE INVENTION

Game consoles (e.g., XBox™ by Microsoft, PS2™ by Sony and GameCube™ by Nintendo, among others) have a mode in which one or more players can represent a team that is playing against one or more other players representing an opposing team. Such modes could be applied to soccer games for example, where one player represents Brazil and another player represents Germany, or strategy war games where one team represents an army and another team represents terrorists. Such games often provide the players with an interactive gaming environment in which verbal communication between the game console and the player is a crucial element of game play. For example, comments in the form of an audio response by the game console to a player during a game can help the player devise his game playing strategy thereby enhancing the gaming experience.

It is desirable that such communications, addressed to one of the teams, are not heard by players representing other teams.

In addition, the present day multilingual DVDs/CDs contain video data along with audio data in multiple languages. It is desirable that persons are able to hear the audio stream in the language of their choice without disturbing a person watching the same DVD/CD in another language.

### SUMMARY OF THE INVENTION

This summary is provided to introduce a selection of concepts in a simplified form that are further described below in the detailed description.

In view of the above, methods for directing an audio stream produced by a home entertainment video hardware system are disclosed. These include sound reproducing devices intended to deliver audible messages to potential recipients. This requires generating an audio stream and identifying the recipients. Sound reproducing devices associated with the recipients are identified. The audio stream is directed to the sound reproducing devices so that only the intended recipients receive the audio stream while other recipients do not.

### BRIEF DESCRIPTION OF THE DRAWINGS

FIG. 1 shows an exemplary implementation of the gaming system.

FIG. 2 shows an exemplary system of the present invention.

### DETAILED DESCRIPTION OF THE PRESENT INVENTION

Overview

Methods and systems for generating private audible messages for the intended recipients are disclosed. A gaming system is disclosed that is capable of directing an audible message to the intended player(s)/recipient(s) without the other players being able to listen to the message.

Systems like game consoles and game programs generate audible messages in the form of audio streams. The game software identifies the sound reproducing device which is intended to produce that audible message. The sound reproducing device can be physically hardwired to an output terminal which receives the audible message generated by the game console system as an audible input for the player(s)/recipient(s) for devising game strategy during gameplay.

In one of the implementations, the sound reproducing device may be headphones, earphones or other similar devices.

In another implementation, the sound reproducing device may be one or more directional speakers. Directional speakers employing ultrasonic sound beams like Audio Spotlight™ from Holosonic Research Labs and Hypersonic™ Sound System (HSS™) from American Technology Corporation have been available for sometime now. The high directionality of ultrasonic sound is used to produce narrow beams. The nonlinear characteristics of air are used to produce audible sound in the desired direction from modulated ultrasonic sound. Similar directional speakers and their working are described in U.S. Pat. No. 4,823,908 (Tanaka, et al) which is incorporated herein by reference. The referred patent describes the manner in which the generation of audio signals takes place by using directional speakers.

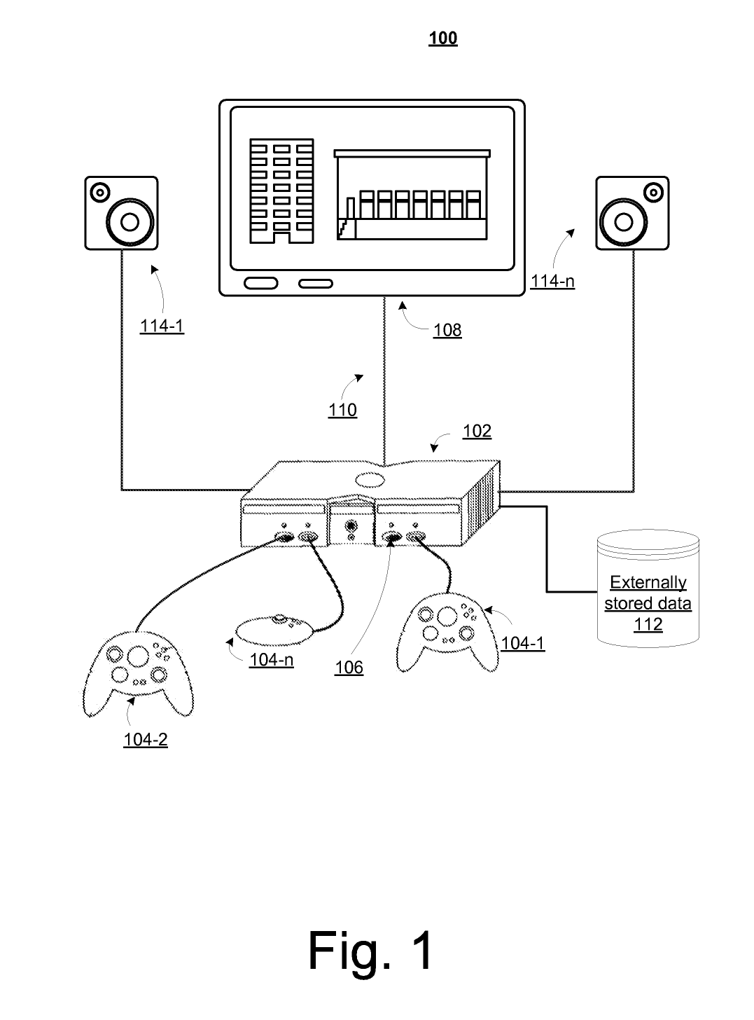

An exemplary system, describing one of the implementations, is shown in FIG. 1. It includes a gaming device 102 and game controllers, as represented by controllers 104(1), 104(2), 104(n). The gaming device 102 is equipped with mass storage devices for example hard disk drive and a portable media drive that supports various forms of portable storage media. Examples of suitable portable storage media include DVD, CD-ROM, other optical discs, game discs, and so forth.

The gaming device 102 has slots 106 to support the connectivity of the controllers 104(1), 104(2), 104(n). Each controller 104 may be coupled to the gaming device 102 via a wired or wireless interface. It would be appreciated that the number and arrangement of slots may be modified. The gaming device 102 connects to a television or other display device 108 through the connection 110. The gaming device is capable of playing games, music, and videos. With different storage offerings, data can be accessed from the hard disk drive or from an external source 112 like a portable storage medium or over a network.

The gaming device 102 is connected to one or more sound reproducing devices 114-1 to 114-n that are responsible for generating sound produced during the game-play. The devices 114-1 to 114-n may be connected to the gaming device through a wired or a wireless medium. In an implementation of the present invention, the sound reproducing devices 114-1 to 114-n can be one or more directional speakers.

Systems and methods for producing audible messages exclusively for the intended recipients are now described in greater detail.

An Exemplary System

In a preferred embodiment, the systems and methods for producing audible messages for the intended recipients can be implemented by computer-executable instructions executed by a computing device such as a PC or a gaming console. Program modules generally include routines, programs, objects, components, data structures, etc., that perform particular tasks or implement particular abstract data types. Such systems and methods may also be implemented in hardware.

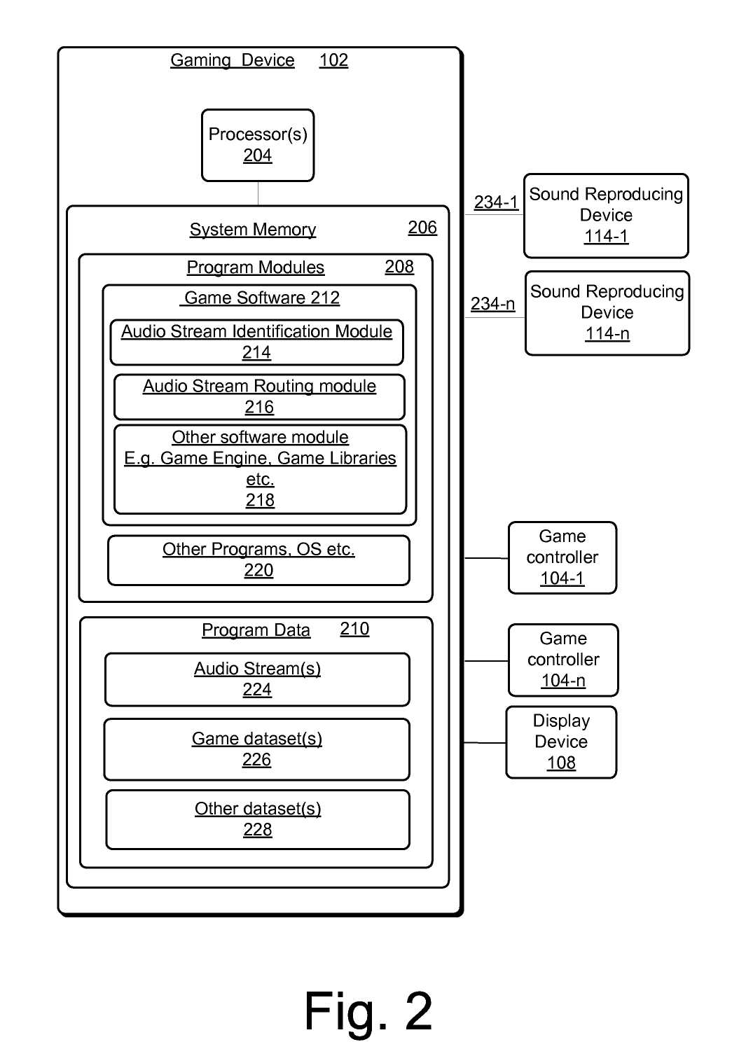

FIG. 2 shows an exemplary system 100 for producing audible messages for the intended recipient. According to one embodiment, system 100 includes a gaming device 102 which further comprises a processor 204, coupled to a system memory 206. The system memory 206 stores program modules 208 and program data 210. After the processor 204 loads program modules 208 and program data 210, it directs communications to the intended player through the sound reproducing devices 114-1 to 114-n. The program data 210 has stored parameters, which, in conjunction with the encoded instructions in the game, cause the gaming device 102 to direct the communications to the intended player.

The program module 208 comprises game software 212 which further comprises an audio stream identification module 214, an audio stream routing module 216 and other software module 218, comprising game engines, game libraries etc. and other software. The program module 208 also includes other programs 220, for carrying out the normal functions of the gaming system 202 and the operating system (OS) which includes drivers for the sound reproducing devices 114-1 to 114-n. Depending on the type of OS, the existing drivers are modified so that the audio streams are routed to the sound reproducing devices 114-1 to 114-n. Such modifications are easily realizable by a person skilled in the art.

The processor 204 is a single processing entity or a plurality of processing entities comprising of multiple computing units. The system memory 206 includes, for example volatile memory (e.g., RAM) and non-volatile memory (e.g., ROM, Flash Memory, etc.). The operational instructions stored in the system memory 206 are executed by the processor 204. The program data 210 of the system memory 206 comprises a plurality of datasets. These may include dataset(s) for storing the audio stream(s) 224, game dataset(s) 226 and other dataset(s) 228. The other dataset(s) 228 store various audio data, video data, graphics data and data generated by the program modules 208 while performing particular tasks or implementing particular abstract data types.

The system 100 further includes handheld controllers 104(1), 104(2), 104(n) which are connected to the gaming device 102 for interacting with and controlling the game software 212. The handheld controllers 104(1), 104(2), 104(n) may be connected to the gaming device 102 through wired or wireless manner. The gaming device 102 is further provided with means which would enable the connection of sound reproducing devices 114-1 to 114-n, which receive audio signals over audio channel(s) 234-1, 234-n respectively. Preferred embodiments include headphone, earphones or directional speakers as the sound reproducing devices 114-1 to 114-n. In another embodiment, a combination of headphone, earphones or directional speakers are used as the sound reproducing devices 114-1 to 114-n. In another embodiment, the sound reproducing devices 114-1 to 114-n are connected to the gaming device 102 through wireless means like Digital Infrared Audio Transmission technology and other wireless technologies.

The gaming device 102 is further connected to a display device 108 like a cathode ray tube, LCD, plasma displays and similar devices through means that are known to the art.

An Exemplary Procedure

During the course of gameplay, the player interacts and controls the game software through the use of the game controllers 104-1 to 104-n. The occurrence of events in the game scenario requires audio streams to be generated and produced as audible messages. Separate audio streams are generated for the each of the events. These streams are messages for different teams, involved in gameplay. The streams are passed to the game engine library in the other software module 218. The audio streams are identified and accepted by the audio stream identification module 214. The audio stream identification module 214, on the basis of the audio stream, identifies the intended recipient and the intended sound reproducing device. The identification by the audio stream identification module 214 is based on data stored in other dataset(s) 228 which comprise of specific parameters to relate the generated audio streams to the corresponding sound reproducing devices 114-1 to 114-n. It would be appreciated by a person skilled in the art that the game engine library in the other software module 218, which is capable of supporting multi-channel audio, is easily alterable to accommodate two or more streams of audio simultaneously.

After the audio stream identification module 214 identifies the intended recipient, the audio stream routing module 216 directs the identified audio stream stored as audio stream(s) 224 to the intended sound reproducing device 114-1 to 114-n.

The identified audio stream 224 is routed to the intended sound reproducing device 114-1 to 114-n that is accessible to the intended recipient. The sound reproduced by the sound reproducing devices 114-1 to 114-n is perceptible to only the intended recipient.

In an implementation, the sound reproducing device 114-1 to 114-n is one or more directional speakers. In case of the directional speakers, the sound produced is highly directional. Only recipients that are placed in the direction in which the sound beam is projected can perceive the sound. Recipients who are not in the specified direction cannot hear the sound.

In another implementation, the sound reproducing device 114-1 to 114-n is a headphone earplugs, etc. In such a case, the sound produced is heard only by the recipient who is wearing the headphones, earplugs etc. In this manner, the privacy of each of the recipients is maintained. The audio message for one of the intended recipient cannot be heard by the other recipient.

In another embodiment of the present invention, sound signals are produced through a TV or another device which supports “Directional Audio” output and such TV or device generates the audible message which is heard only by the intended recipient.

In another embodiment, the system and method as disclosed are employed in DVD/CD/Blu-Ray Discs/HD-DVD players. Such discs contain the video data along with audio data in different languages. The video is displayed on a common display. Depending upon selection by the viewers, audio in different languages is directed to different channels connected to the directional audio devices. This allows the viewers to watch the same video, but hear the audio in a language of their choice.

The preceding description has provided a gaming system which allows the gaming device to generate messages permitting only the intended recipient to hear the messages. Such a system ensures privacy to player(s) who are playing the game thereby providing a better realistic environment.

Although the systems and methods as disclosed have been described in language specific to structural features and/or methodological operations or actions, it is understood that the implementations defined in the appended claims are not necessarily limited to the specific features or actions described. Rather, the specific features and operations of system 100 are disclosed as exemplary forms of implementing the claimed subject matter and are not intended to limit the scope of the subject matter disclosed herein

I/we claim:

1. A method of directing an audio stream produced by a home entertainment video hardware system comprising sound reproducing devices, to a targeted subset of potential recipients capable of receiving said streams, the method comprising:
a. generating an audio stream;
b. identifying one or more intended recipients of the targeted subset;
c. identifying speakers associated with each of the intended recipients; and
d. directing the audio stream to the identified speakers such that the intended recipients receive the audio stream to the exclusion of all other potential recipients.

2. The method of claim 1, wherein the audio stream is in more than one language.

3. The method of claim 1, wherein the sound reproducing device is a directional audio speaker.

4. The method of claim 1, wherein the sound reproducing device is selected from a group comprising of a head phone, an ear phone or other portable devices.

5. The method of claim 1 wherein the home entertainment video system is a DVD player.

6. The method of claim 1 wherein the audio stream is a DVD audio stream in a particular language

7. A system in a home entertainment video hardware system comprising speakers, a processor, coupled to a memory, capable of executing a set of instructions stored in the memory for:
a. generating an audio stream;
b. identifying one or more intended recipients of the targeted subset;
c. identifying speakers associated with each of the intended recipients; and
d. directing the audio stream to the identified speakers such that the intended recipients receive the audio stream to the exclusion of all other potential recipients.

8. The system of claim 7, wherein the audio stream is in more than one language.

9. The system of claim 7, wherein the sound reproducing device is a directional audio speaker.

10. The system of claim 7, wherein the sound reproducing device is selected from a group comprising of a head phone, an ear phone or other portable devices.

11. A gaming system comprising a processor, coupled to a memory and one or more controllers, the processor being capable of executing a set of instructions stored in the memory for:
a. generating an audio stream;
b. identifying one or more intended recipients of the targeted subset;
c. identifying speakers associated with each of the intended recipients; and
d. directing the audio stream to the identified speakers such that the intended recipients receive the audio stream to the exclusion of all other potential recipients.

12. The gaming system of claim 11, wherein the audio stream is in more than one language.

13. The gaming system of claim 11, wherein the sound reproducing device is a directional audio speaker.

14. The gaming system of claim 11, wherein the sound reproducing device is selected from a group comprising of a head phone, an ear phone or other portable devices.
